(19) United States
(12) Patent Application Publication
(10) Pub. No.: US 2009/0009359 A1
(43) Pub. Date: Jan. 8, 2009

(54) Method of Monitoring Commodity Consumption

(75) Inventor: Luigi A. Belverato, Munich (DE)

Correspondence Address: DUANE MORRIS LLP - Philadelphia;IP DEPARTMENT, 30 SOUTH 17TH STREET, PHILADELPHIA, PA, 19103-4196, US

(73) Assignee: LSI CORPORATION, Milpitas, CA (US)

(21) Appl. No.: 11/773,528

(22) Filed: Jul. 5, 2007

(51) Int. Cl. G08B 23/00

(52) U.S. Cl. 340/870.02

(57) ABSTRACT

A method and a system for monitoring the quantity of the commodity consumed by a consumer comprises receiving during a preset reporting period window an output value that is security protected from the consumer, extracting a consumption value and a time stamp value from the output value, the extracted values being associated with the quantity, and generating an invoice for the consumer for the quantity of the commodity consumed.

### FIELD OF THE INVENTION

The present invention relates to a method of monitoring a commodity such as gas, electricity or water being consumed by a consumer.

### BACKGROUND

Generally, the pay-for-usage billing associated with consumption of commodity services such as electricity, gas and water is facilitated by consumption meters installed at the consumer's location. The consumption meters measure the amount of the commodity consumed and display an output representing the accumulating consumption. Traditionally, a meter reader, a representative of the service provider, periodically visited each consumer's location to collect the data from the consumption meters on the quantity of the commodity consumed by the consumer since the previous reading and the consumer was billed accordingly.

To make the periodic meter reading of the consumption meters more efficient and accurate, various automatic meter reading (“AMR”) technologies have been developed. AMR is the technology of automatically collecting data from consumption meters and transferring that data to a central database located at the commodity service provider. The transmitted reading data is then used by the commodity service provider for billing and analyzing.

AMR technologies include handheld, mobile and fixed network technologies based on telephony platforms (wired and wireless), radio frequency, or powerline transmission. For example, handheld radio frequency AMRs collect meter readings from AMR capable consumption meters (usually wirelessly) and transmit the data to the central database but still require a meter reader, a person, to walk-by or drive-by the consumption meters with a handheld or mobile units. Fixed network AMR system uses a permanently installed network to capture meter readings and transmit to the central database. This method generally requires a series of antennas, towers, collectors, repeaters, or other permanently installed infrastructure to collect transmissions of meter readings from AMR capable consumption meters and get the data to the central database. Such permanent network system eliminates the need for a person in the field to collect the meter reading data but the various hardware associated the fixed network is expensive and require capital expenditures on the part of the commodity service provider.

Therefore, there is a need for an improved method to collect readings from consumption meters.

### SUMMARY

According to an embodiment, a method for monitoring a quantity of a commodity consumed by a consumer is disclosed. The method comprises receiving an output value from the consumer during a preset reporting period window, extracting a consumption value and a time stamp value, associated with the quantity, from the output value, and generating an invoice for the consumer for the quantity of the commodity consumed. The output value is security protected so that the content of the output value can not be tampered with by the consumer. This allows the monitoring party to trust the output value being reported by the consumer.

According to another embodiment, a consumption meter for monitoring the quantity of a commodity consumed by a consumer is disclosed. The consumption meter is located at the consumer's location and comprises a measuring unit for measuring the quantity of the commodity consumed by the consumer. The measuring unit is preferably an electronic digital device and is configured to measure and generate a consumption value representing the measured quantity of the commodity consumed. The consumption meter also includes a clock circuit configured for generating a real-time time stamp value representing the clock time when the measuring unit generated the consumption value. The consumption meter also includes a processor unit that is configured to handle the operation of the consumption meter. The processor unit is configured with an appropriate firmware to convert the consumption value and the time stamp value into an output value and displays the output value on the consumption meter's display unit. Preferably, the output value is security protected using a data integrity check algorithm and displays the security-protected output value in a form readable by the consumer.

At the monitoring party's location remote from the consumer's location is a central processing unit configured to extract the consumption value and the time stamp value from the output value received from the consumer. Preferably, the output value is security-protected and the extracting process includes removing the security protection from the security-protected output value.

The consumer can report the security-protected output value that is displayed by the consumption meter to the monitoring party by one of a variety of communication means. The consumer can report by telephone, by email, through the monitoring party's website, or via regular mail, etc. The consumer reports the output value to the monitoring party during a preset reporting period window.

Because data authentication or encryption is incorporated into the method described herein, the information reported by the consumer to the monitoring party can be readily trusted and reliable. The additional benefit of the system and method described herein is that because the consumer reports the consumption value information from the consumption meter to the monitoring party, such as a commodity provider, the monitoring party does not have to send a person, a meter reader, to take the periodic reading from the consumption meter located at a consumer's location and unlike the fixed network AMR systems, the costs associated with the fixed network hardware is not necessary. The costs associated with the additional components in the processor unit that enables generation of the encrypted output value is negligible compared to the cost associated with a fixed network AMR or a meter reader personnel.

Also, the consumer does not have to be concerned with giving the meter reader an access to the consumer's premises at inconvenient times. The system allows the commodity provider to make an arrangement with the consumer to report the encrypted output value at the consumer's convenience during a preset reporting period window. The consumer can report the encrypted output value by a telephone call or an email for convenience.

### BRIEF DESCRIPTION OF THE DRAWINGS

The features of the preferred embodiments will be described with reference to the following drawings where like elements are labeled similarly, and in which:

FIG. 1 is a flowchart illustrating an embodiment; and

FIG. 2 is a block diagram of the system embodiment of the invention.

### DETAILED DESCRIPTION

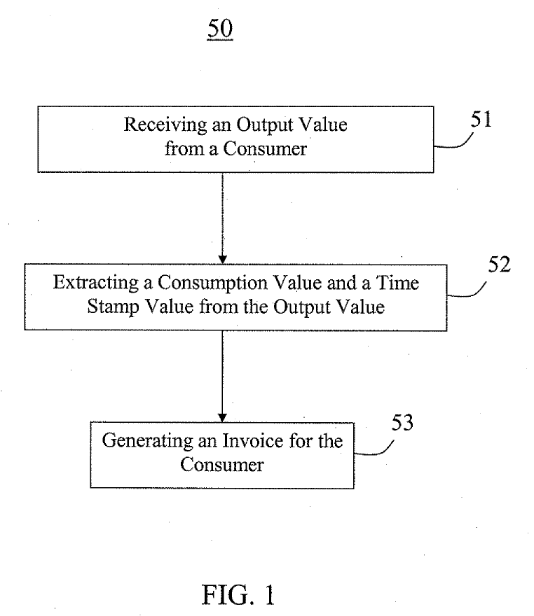

Referring to FIG. 1, a flowchart 50 for the steps involved in a method for monitoring a quantity of a commodity consumed by a consumer according to an embodiment is disclosed.

At step 51, the monitoring party receives an output value from the consumer during a preset reporting period window. The benefit of the present method is that the receipt of the output value is directly from the consumer and not from a third party, such as a meter reader. The output value comprises a consumption value and a real-time time stamp value and is generated by a consumption meter located at a consumer's location. Preferably, the output value is security protected so that the informational content of the output value can not be changed or otherwise tampered with by the consumer or any other party before being received by the monitoring party.

At step 52, the monitoring party extracts the consumption value and the time stamp value from the security-protected output value received from the consumer.

At step 53, the monitoring party then generates an invoice for the consumer for the quantity of the commodity consumed.

The consumption value represents the quantity of the commodity consumed by the consumer as measured by the consumption meter. The time stamp value represents the clock time when the consumption value was generated. The time stamp makes the measurement of the consumption value independent from when the consumer actually reports the consumption value to the monitoring party.

Preferably, in generating the security-protected output value, the consumption meter may utilize a data integrity check algorithm to convert the measured consumption value and the time stamp value to a security-protected output value. In such embodiment, the extracting step 52 in the flowchart 50 would include removal of the security protection from the output value. For example, if the data integrity check algorithm is an encryption algorithm that encrypts the output value, the security protection removal will involve an associated decryption process using the encryption algorithm. The consumption meter would operate an encryption algorithm on the consumption value and the time stamp value to generate the security-protected output value. After the consumer reports the output value displayed by the consumption meter to the monitoring party, generally the commodity provider, the monitoring party operates an appropriate decryption algorithm on the security-protected output value to extract the consumption value and the time stamp value. An example of such encryption algorithm may be the type where a public encryption key of the recipient is used to encrypt the data and the recipient then uses his own private key to decrypt it. Thus, in this embodiment, the consumption meter would encrypt using the public key of the monitoring party to generate the security-protected output value and then the monitoring party removes the security protection from the output value by decrypting the data with the monitoring party's private key.

According to another embodiment, the data integrity check algorithm can be an error-detecting algorithm such as a cyclic redundancy check algorithm or a checksum algorithm. Such error-detecting algorithm takes an input value (in this case the consumption value and the time stamp value taken together) and generates a data integrity check value. In this embodiment, the security-protected output value displayed by the consumption meter consists of the combination of the input value and the data integrity check value.

After the consumer reports the security-protected output value to the monitoring party, the monitoring party operates the error-detecting algorithm on the input value portion of the received security-protected output value and generates a second data integrity check value. If the second data integrity check value matches the data integrity check value portion of the security-protected output value reported by the consumer, the monitoring party is assured that the input value received is accurate.

As noted above, the consumer reports the security-protected output value to the monitoring party and this reporting is carried out periodically on a set schedule. This schedule can be on a preset schedule or the monitoring party can prompt the consumer when a reporting is required. The consumer reads the output value displayed on the consumption meter and reports it to the monitoring party.

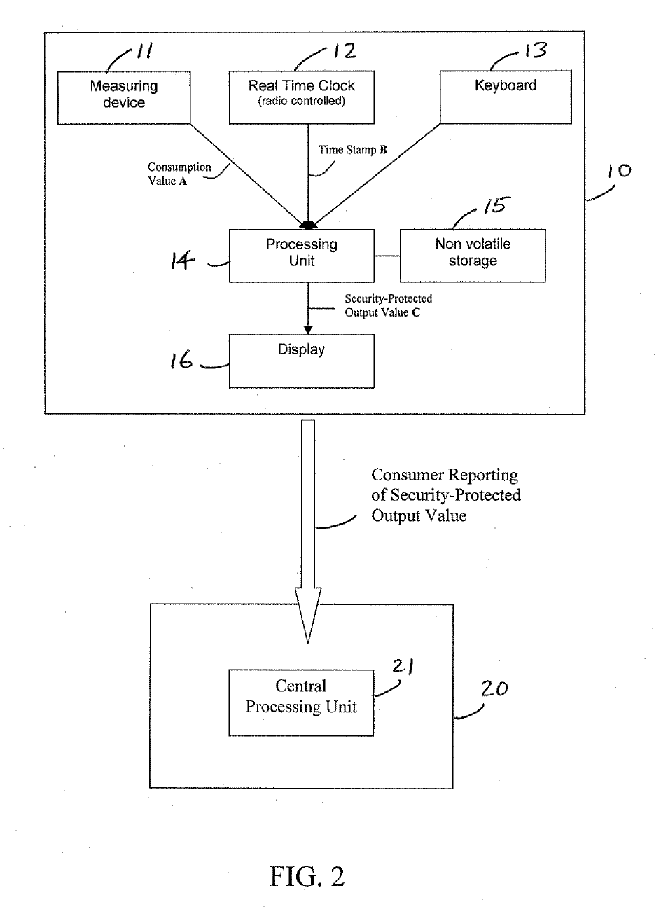

Referring to FIG. 2, a system for monitoring the quantity of a commodity consumed by a consumer is disclosed. The system includes a consumption meter 10, located at the consumer's location, comprising a measuring unit 11 configured for measuring the quantity of the commodity consumed by the consumer. The measuring unit 11 is preferably an electronic device and is configured to generate a consumption value A representing the measured quantity of the commodity consumed. More preferably, the electronic measuring unit 11 is a digital device and generates the measured output in digitally encoded signal form.

The consumption meter 10 can include a clock circuit 12 configured for generating a real-time time stamp value B. The time stamp value B represents the clock time when the measuring unit 11 generated the consumption value. The clock circuit can be a radio-controlled type that keeps time by receiving the broadcast atomic clock signals so that it can keep accurate time without human attention. The consumption meter 10 also includes a processing unit 14 that is configured to manage the operation of the consumption meter 10. The processing unit 14 is configured with an appropriate firmware or software to convert the consumption value A and the time stamp value B into a security-protected output value C using a data integrity check algorithm and displays the output value C on a display 16 that is also provided as a part of the consumption meter 10. The processing unit 14 can be configured to have the data integrity check algorithm hard-coded into the processing unit, or optionally, the processing unit 14 can be provided with an associated non-volatile storage memory 15 where the data integrity check algorithm can be stored and accessed by the processing unit 14 when necessary.

In an embodiment, where the data integrity check algorithm is an encryption algorithm, as described above, the private key of the consumption meter and the public key of the monitoring party can be stored in the storage memory 15. The processing unit 14 can be a simple general purpose processor that is well known to one of ordinary skill in the art. The display 16 can be any one of commonly available LCD or LED display devices appropriately sized for this type of application.

The consumption meter 10 can be configured with an optional keyboard or a keypad unit 13 to allow the consumer to access appropriate functions of the consumption meter. Fore example, the display unit 16 can be configured to be normally in off state to conserve energy and the consumer can turn it on by pressing a key on the keyboard 13 to trigger the security-protected output value to be displayed.

This system also includes a central processing unit 21 located at the monitoring party's location 20 remote from the consumer's location. In an embodiment where the output value from the consumption meter is security protected, the central processing unit 21 is configured with appropriate software tools to remove the security protection from the output value and extract the consumption value and the time stamp value after the consumer reports the output value to the monitoring party.

While the foregoing description and drawings represent preferred or exemplary embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. The presently disclosed embodiments are therefore to be considered in all respects as illustrative and not restrictive, the scope of the invention being defined by the appended claims, and not limited to the foregoing description or embodiments. Rather, the appended claims should be construed broadly, to include other variants and embodiments of the invention, which may be made by those skilled in the art without departing from the scope and range of equivalents of the invention.

What is claimed is:

1. A method for monitoring a quantity of a commodity consumed by a consumer, said method comprising:
receiving, during a preset reporting period window, a security-protected output value from the consumer;
extracting a consumption value and a time stamp value, associated with the quantity, from the security-protected output value; and
generating an invoice for the consumer for the quantity of the commodity consumed.

2. The method of claim 1, wherein the extracting step comprises removing a security protection from the security-protected output value using a decryption algorithm.

3. The method of claim 1, wherein the extracting step comprises removing a security protection from the output value using a cyclic redundancy check algorithm.

4. The method of claim 1, wherein the extracting step comprises removing a security protection from the output value using a checksum algorithm.
